(19) United States
(12) Patent Application Publication
(10) Pub. No.: US 2011/0265990 A1
(43) Pub. Date: Nov. 3, 2011

(54) Sand Control Screen Assembly Having a Surface-Modified Filter Medium and Method for Making Same

(75) Inventors: Jody R. Augustine, League City, TX (US); Ronald Glen Dusterhoft, Katy, TX (US)

(73) Assignee: Halliburton Energy Services, Inc., Carrollton, TX (US)

(21) Appl. No.: 12/768,901

(22) Filed: Apr. 28, 2010

(51) Int. Cl. E03B 3/22; B23P 15/16; E03B 3/18

(52) U.S. Cl. 166/230; 166/227; 29/896.62

(57) ABSTRACT

A sand control screen assembly (100) positionable within a wellbore (26) for filtering particulate matter out of production fluids. The sand control screen assembly (100) includes a perforated base pipe (102) that allows fluid flow therethrough and a filter medium (124) disposed exteriorly about the base pipe (102). A surface-modified agent is disposed on at least a portion of the filter medium (124). The surface-modified agent is operable to enhance the surface filter characteristics of the filter medium (124), thereby reducing particulate infiltration into the filter medium (124).

### TECHNICAL FIELD OF THE INVENTION

This invention relates, in general, to a sand control screen assembly used in a wellbore that traverse a subterranean hydrocarbon bearing formation and, in particular, to a sand control screen assembly having a surface-modified filter medium and method for making same.

### BACKGROUND OF THE INVENTION

Without limiting the scope of the present invention, its background will be described in relation to sand control screen assemblies operating in a wellbore that traverses a subterranean hydrocarbon bearing formation, as an example.

Since the beginning of oil production from subsurface formations, the industry has been concerned with efficient control of the movement of unconsolidated formation particles, such as sand, into the wellbore. For example, such particle movement commonly occurs during production from completions in loose sandstone or following hydraulic fracture of a formation. Production of these materials causes numerous problems in the operation of oil, gas or water wells. These problems include plugging of formations, tubing and subsurface flow lines, as well as erosion of tubing, downhole equipment and surface equipment. These problems lead to high maintenance costs and undesirable downtime of wells. Accordingly, numerous methods have been attempted to control the movement of unconsolidated particles during the production of fluids.

One such method is the use of prepacked sand control screen assemblies. Generally, an inner wire screen is affixed to a plurality of ribs that extend longitudinally along the outer surface of a perforated base pipe. An outer wire screen is disposed about the inner screen to create an annular space between the two wire screens into which a resin coated sand may be confined. These prepacked sand control screens may be constructed by first fabricating the metal components, then forcing the pack sand into the desired location such as between the inner wire screen and the outer wire screen of a multi-layer screen as discussed above.

Prepacked sand control screen assemblies may operate differently based on their design. For example, some prepacked sand control screen assemblies operate substantially as a depth filter. Depth filters typically utilize a filtering medium having a relatively significant thickness that provides for filtering throughout the depth of the filtering medium. In general, larger particles may be trapped at the surface layer, while finer particles are trapped by succeeding inner layers.

It has been found, however, that depth type prepacked sand control screen assemblies are prone to plugging, especially where a significant amount of fines exists in an unconsolidated formation. As a prepacked sand control screen assembly becomes plugged, production therethrough becomes less efficient. In addition, depth type prepacked sand control screen assemblies are difficult to clean.

In contrast, surface type filter systems are easily cleaned because the trapped particles may simply be washed off the surface of the assembly. For example, certain sand control screen assemblies that are sometimes referred to as premium screens, utilize a wire mesh or woven mesh type filter medium that operates substantially as a surface filter. Unconsolidated formation particles that are trapped on the outer surface of this type of filtration medium may then be cleaned off by either backwashing or injecting cleaning fluids on the filtering surface.

It has been found, however, that premium screens may suffer from erosion problems, such as pin hole erosion, created by fine particles or streams of fine particles that travel through the wire mesh layers of these screens. Once a pin hole is formed, there is generally no additional filtering medium inward of the penetrated wire mesh or woven mesh, thus fine particles may go through the pin hole unabated. This fine stream of particles may then further erode the filter medium resulting in a large diameter opening.

Accordingly, a need has arisen for a sand control screen assembly that is capable of filtering fines out of a production stream from a subterranean hydrocarbon bearing formation. A need has also arisen for such a sand control screen assembly that resists plugging and is operable to be cleaned to remove particle buildup. Further, a need has arisen for such a sand control screen assembly that does not suffer from pin hole erosion.

### SUMMARY OF THE INVENTION

The present invention disclosed herein is directed to an improved sand control screen assembly having a surface-modified filter medium that provides improved sand control in downhole operations. Specifically, the sand control screen assembly of the present invention is capable of filtering fines out of a production stream from a subterranean hydrocarbon bearing formation. In addition, the sand control screen assembly of the present invention resists plugging and is operable to be cleaned to remove particle buildup. Further, the sand control screen assembly of the present invention does not suffer from pin hole erosion.

In one aspect, the present invention is directed to a sand control screen assembly that is positionable within a wellbore for filtering particulate matter out of production fluids. The sand control screen assembly includes a perforated base pipe that allows fluid flow therethrough and a filter medium disposed exteriorly about the base pipe. A surface-modified agent is disposed on at least a portion of the filter medium. The surface-modified agent is operable to enhance the surface filter characteristics of the filter medium, thereby reducing particulate infiltration into the filter medium.

In one embodiment, the filter medium includes prepack sand or prepack gravel. In another embodiment, the filter medium includes fabric mesh and/or wire mesh screening elements. In one embodiment, the surface-modified agent may be an acrylic acid polymer, an acrylic acid ester polymer, an acrylic acid derivative polymer, an acrylic acid homopolymer, an acrylic acid ester homopolymer, an acrylamido-methyl-propane sulfonate polymer, an acrylamido-methyl-propane sulfonate derivative polymer, an acrylamido-methyl-propane sulfonate copolymer, an acrylic acid/acrylamido-methyl-propane sulfonate copolymer, copolymers thereof or mixtures thereof. In another embodiment, the surface-modified agent may be activated by an activator such as an organic acid, an anhydride of an organic acid, an inorganic acid, an inorganic salt, a charged surfactant, a charged polymer or combinations thereof. In yet another embodiment, the filter medium may be pretreated to improve the surface receptivity of the filter medium to the surface-modified agent.

In another aspect, the present invention is directed to a sand control screen assembly that is positionable within a wellbore for filtering particulate matter out of production fluids. The sand control screen assembly includes a perforated base pipe that allows fluid flow therethrough. A first screen element is disposed exteriorly about the base pipe. A second screen element is disposed exteriorly of the first screen element forming a region therebetween. A prepack filter medium is disposed in the region between the first and second screen elements. A surface-modified agent is disposed on at least a portion of the filter medium. The surface-modified agent is operable to enhance the surface filter characteristics of the filter medium, thereby reducing particulate infiltration into the filter medium.

In a further aspect, the present invention is directed to a method for making a sand control screen assembly. The method includes providing a base pipe having a plurality of perforation therethrough, positioning a filter medium exteriorly about the base pipe and applying a surface-modified agent to at least a portion of the filter medium, the surface-modified agent operable to enhance the surface filter characteristics of the filter medium, thereby reducing particulate infiltration into the filter medium.

The method may also include activating the surface-modified agent with an activator selected from the group consisting of an organic acid, an anhydride of an organic acid, an inorganic acid, an inorganic salt, a charged surfactant, a charged polymer and combinations thereof, pretreating the filter medium with one of a cationic compound and a cationic polymer or pretreating the filter medium with one of an anionic compound and an anionic polymer.

### BRIEF DESCRIPTION OF THE DRAWINGS

For a more complete understanding of the features and advantages of the present invention, reference is now made to the detailed description of the invention along with the accompanying figures in which corresponding numerals in the different figures refer to corresponding parts and in which:

FIG. 1 is a schematic illustration of an offshore platform operating a sand control screen assembly having a surface-modified filter medium according to an embodiment of the present invention;

FIG. 2 is a side elevation view, partially cut away, of a sand control screen assembly having surface-modified prepack sand according to an embodiment of the present invention;

FIG. 3 is a cross sectional view of the sand control screen assembly having surface-modified prepack sand of FIG. 2;

FIG. 4 is a side elevation view, partially cut away, of a sand control screen assembly having surface-modified prepack sand according to an embodiment of the present invention;

FIG. 5 is a cross sectional view of the sand control screen assembly having surface-modified prepack sand of FIG. 4;

FIG. 6 is a side elevation view, partially cut away, of a sand control screen assembly having surface-modified prepack sand according to an embodiment of the present invention;

FIG. 7 is a cross sectional view of the sand control screen assembly having surface-modified prepack sand of FIG. 6;

FIG. 8 is a side elevation view, partially cut away, of a sand control screen assembly having a surface-modified wire mesh screen according to an embodiment of the present invention;

FIG. 9 is a cross sectional view of the sand control screen assembly having a surface-modified wire mesh screen of FIG. 8;

FIG. 10 is an enlarged photomicrographic view of surface-modified prepack sand according to an embodiment of the present invention;

FIG. 11 is an enlarged photomicrographic view of surface-modified prepack gravel according to an embodiment of the present invention;

FIG. 12 is an enlarged front view of a surface-modified fabric mesh according to an embodiment of the present invention; and

FIG. 13 is an enlarged cross sectional view of a surface-modified wire mesh according to an embodiment of the present invention.

### DETAILED DESCRIPTION OF THE INVENTION

While the making and using of various embodiments of the present invention are discussed in detail below, it should be appreciated that the present invention provides many applicable inventive concepts which can be embodied in a wide variety of specific contexts. The specific embodiments discussed herein are merely illustrative of specific ways to make and use the invention, and do not delimit the scope of the present invention.

In the following description of the representative embodiments of the invention, directional terms, such as “above”, “below”, “upper”, “lower”, etc., are used for convenience in referring to the accompanying drawings. In general, “above”, “upper”, “upward” and similar terms refer to a direction toward the earth's surface along a wellbore, and “below”, “lower”, “downward” and similar terms refer to a direction away from the earth's surface along the wellbore.

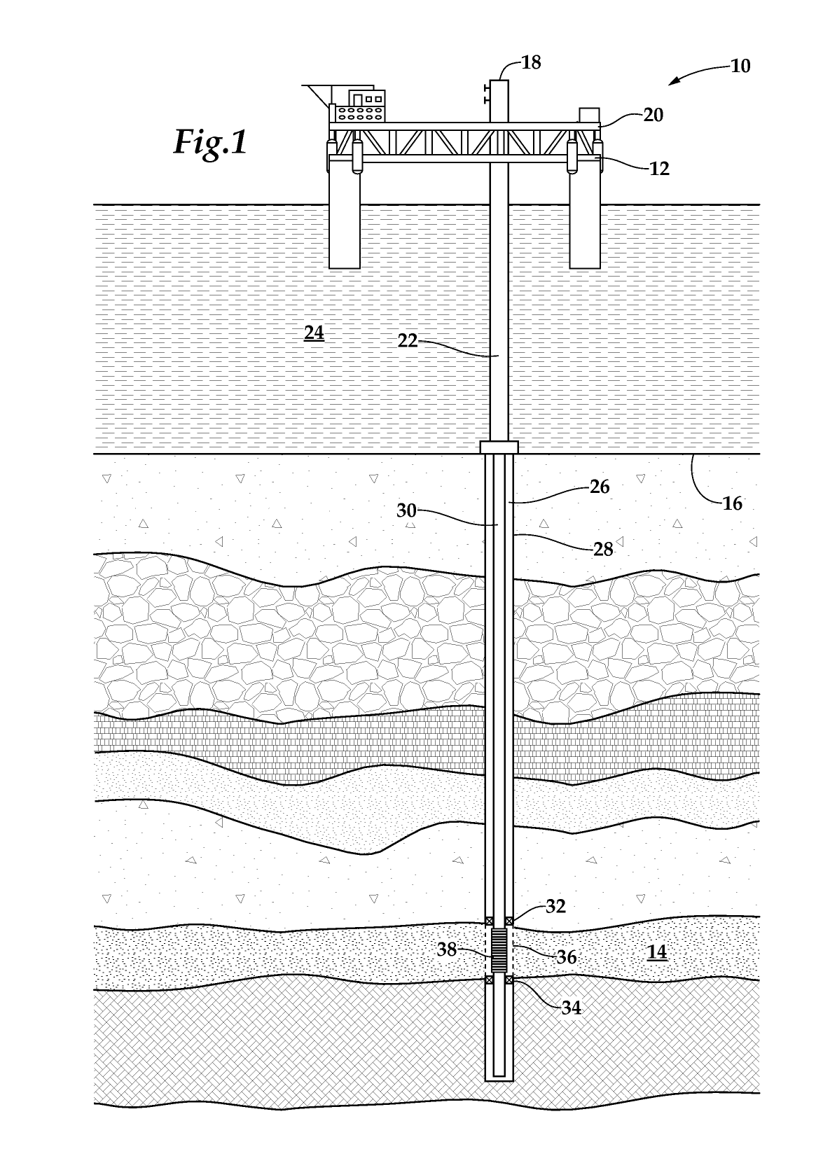

Referring to FIG. 1, a sand control screen assembly having a surface-modified filter medium in use with an offshore oil and gas production platform is schematically illustrated and generally designated 10. A semi-submersible platform 12 is centered over a submerged oil and gas formation 14 located below sea floor 16. Wellhead 18 is located on deck 20 of platform 12. Well 22 extends through the sea 24 and penetrates the various earth strata including formation 14 to form wellbore 26. Disposed within wellbore 26 is casing 28. Disposed within casing 28 and extending from wellhead 18 is production tubing 30. A pair of seal assemblies 32, 34 provides a seal between tubing 30 and casing 28 to prevent the flow of production fluids therebetween. During production, formation fluids enter wellbore 26 through perforations 36 of casing 28 and travel into tubing 30 to wellhead 18. As part of the final bottom hole assembly, a sand control screen assembly having a surface-modified filter medium 38 is included within tubing 30. Sand control screen 38 filters the particles out of the formation fluids as the formation fluids are produced.

Even though FIG. 1 depicts a sand control screen of the present invention in a cased hole environment, it should be understood by those skilled in the art that the sand control screens of the present invention are equally well suited for use in open hole environments. Also, even though FIG. 1 depicts a single sand control screen of the present invention, it should be understood by those skilled in the art that any number of sand control screens of the present invention may be deployed within a production interval without departing from the principles of the present invention. In addition, even though FIG. 1 depicts a sand control screen of the present invention in a vertical wellbore, it should be understood by those skilled in the art that the sand control screens of the present invention are equally well suited for use in well having other directional configurations including horizontal wells, deviated wellbores, slanted wells, multilateral well and the like.

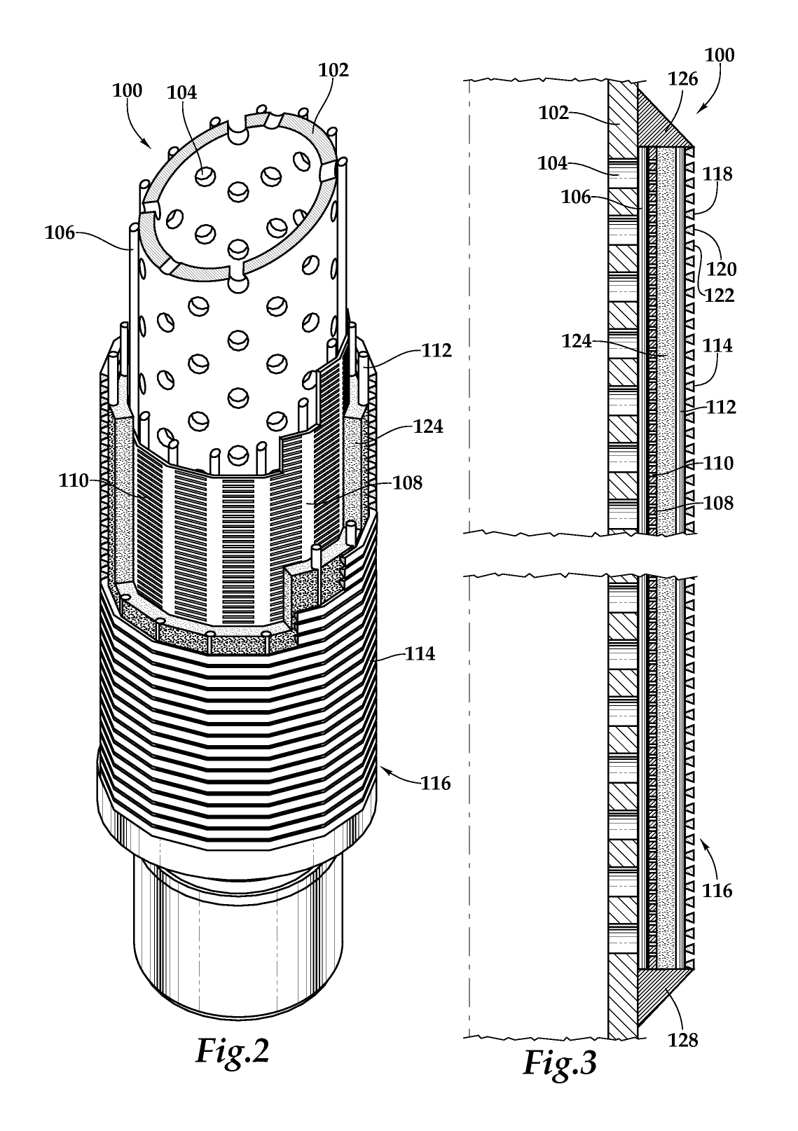

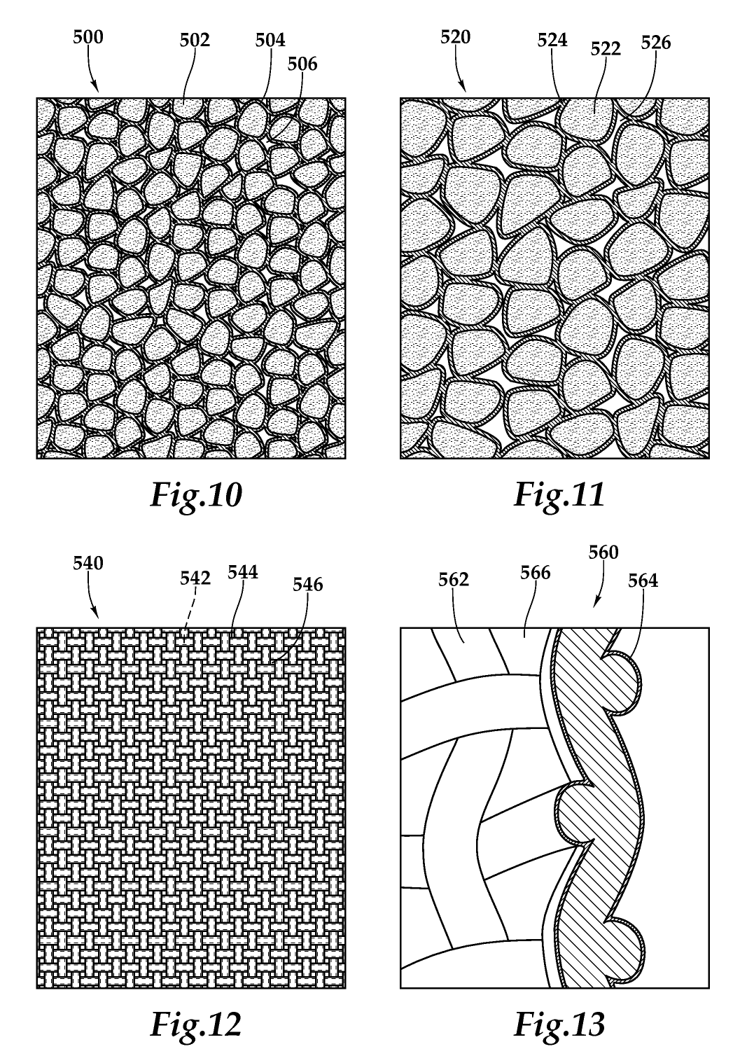

Referring to FIGS. 2-3, one embodiment of a sand control screen assembly having a surface-modified filter medium is depicted and generally designated 100. Sand control screen assembly 100 includes a base pipe 102 having a plurality of openings 104. Sand control screen assembly 100 also includes a plurality of ribs 106 that are substantially symmetrically disposed or positioned about the axis of base pipe 102. A slotted screen 108 including a plurality of slotted openings 110 is wrapped around ribs 106. Substantially symmetrically disposed or positioned about slotted screen 108 is a plurality of ribs 112. Wrapped around ribs 112 is a screen wire 114 that forms a plurality of turns such as turns 118, 120, 122 having gaps therebetween. Disposed in the annular area between slotted screen 108 and screen wire 114 is a filter medium depicted as surface-modified prepack sand 124. As described above, conventional prepacked sand control screens operate substantially as depth filters wherein larger particles may be trapped at the surface layer, while finer particles are trapped within the filter medium. As the fines begin to plug such screens, production efficiency is reduced. In addition, these depth type prepacked sand control screens are difficult to clean. The surface-modified agent of the present invention is operable to enhance the surface filter characteristics of filter medium 124 which reduces particulate infiltration into filter medium 124, thus converting filter medium 124, at least in part, from a depth filter to a surface filter. As such, formation particles that previously infiltrated prepacked filter media now build up on the outer surface filter medium 124 thus enabling cleaning of filter medium 124 by backwashing, chemical injection or the like. A further description of surface-modified prepack sand 124 is provided below with reference to FIGS. 10-11. Together, ribs 106, slotted screen 108, surface-modified prepack sand 124, ribs 112, and screen wire 114 form sand control screen jacket 116. Sand control screen jacket 116 is attached to base pipe 102 at its upper end by weld 126 and its lower end by weld 128.

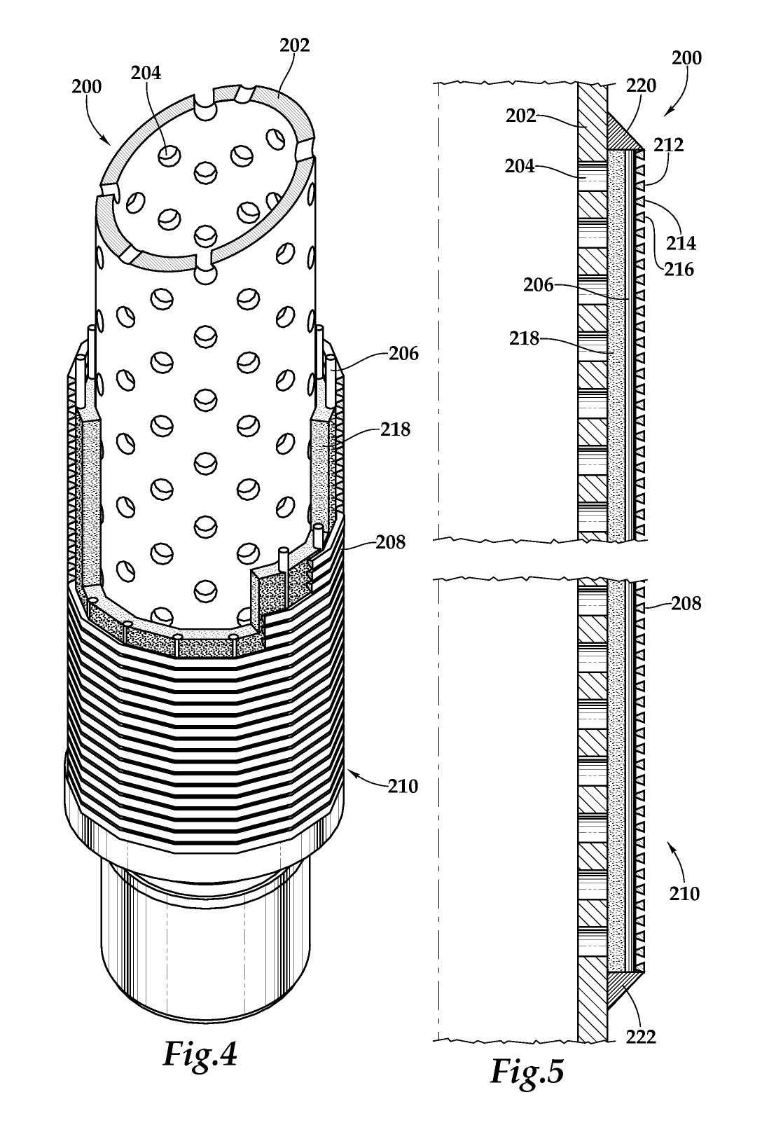

Referring next to FIGS. 4-5, another embodiment of a sand control screen assembly having a surface-modified filter medium is depicted and generally designated 200. Sand control screen assembly 200 includes a base pipe 202 having a plurality of openings 204. Sand control screen assembly 200 also includes a plurality of ribs 206 that are substantially symmetrically disposed or positioned about the axis of base pipe 202. Wrapped around ribs 206 is a screen wire 208 that forms a plurality of turns such as turns 212, 214, 216 having gaps therebetween. Disposed in the annular area between base pipe 202 and screen wire 208 is a filter medium depicted as surface-modified prepack sand 218. Use of the surface-modified agent on the pack sand enhances the surface filter characteristics of filter medium 218 which reduces particulate infiltration into filter medium 218, thus converting filter medium 218, at least in part, from a depth filter to a surface filter. A further description of surface-modified prepack sand 218 is provided below in reference to FIGS. 10-11. Together, ribs 206, surface-modified prepack sand 218, and screen wire 208 form sand control screen jacket 210. Sand control screen jacket 210 is attached to base pipe 202 at its upper end by weld 220 and its lower end by weld 222.

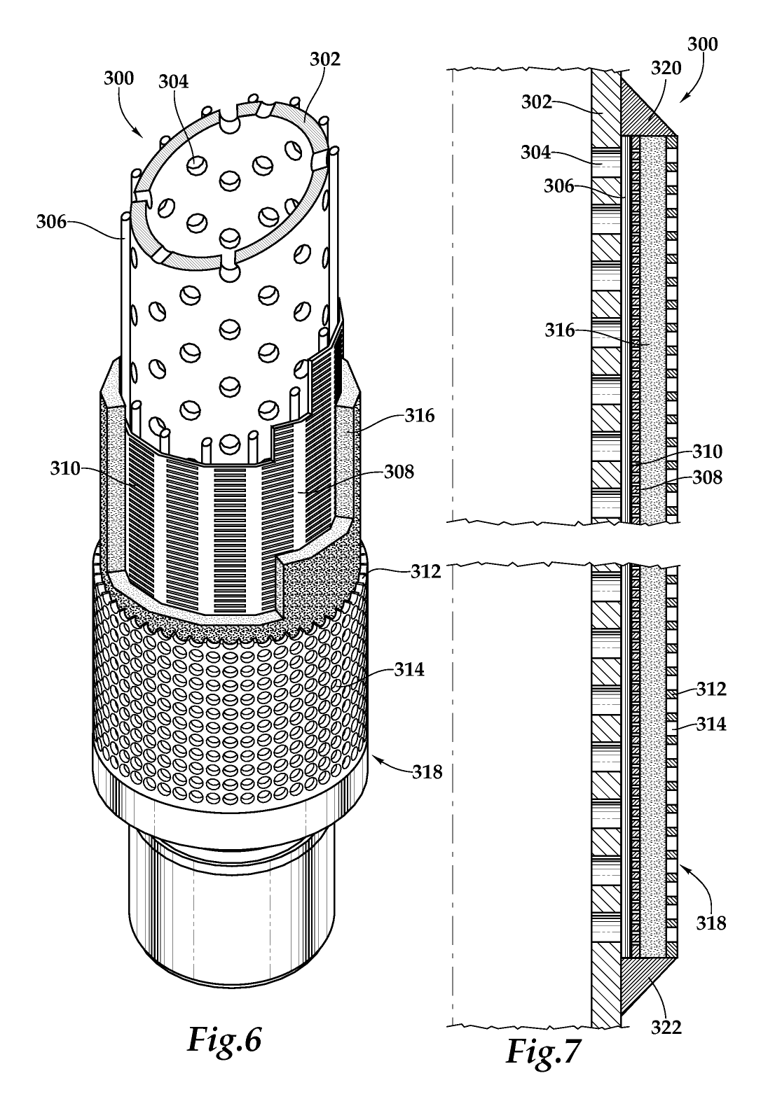

Turning now to FIGS. 6-7, yet another embodiment of a sand control screen assembly having surface-modified filter medium is depicted and generally designated 300. Sand control screen assembly 300 includes a base pipe 302 having a plurality of openings 304. Sand control screen assembly 300 also includes a plurality of ribs 306 that are substantially symmetrically disposed or positioned about the axis of base pipe 302. A slotted screen 308 including a plurality of slotted openings 310 is wrapped around ribs 306. A shroud 312 including a plurality of openings 314 is positioned around slotted screen 308. Disposed in the annular area between slotted screen 308 and shroud 312 is a filter medium depicted as surface-modified prepack sand 316. Use of the surface-modified agent on the pack sand enhances the surface filter characteristics of filter medium 316 which reduces particulate infiltration into filter medium 316, thus converting filter medium 316, at least in part, from a depth filter to a surface filter. A further description of surface-modified prepack sand 316 is provided below in reference to FIGS. 10-11. Together, ribs 306, slotted screen 308, surface-modified prepack sand 316, and shroud 312 form sand control screen jacket 318. Sand control screen jacket 318 is attached to base pipe 302 at its upper end by weld 320 and its lower end by weld 322.

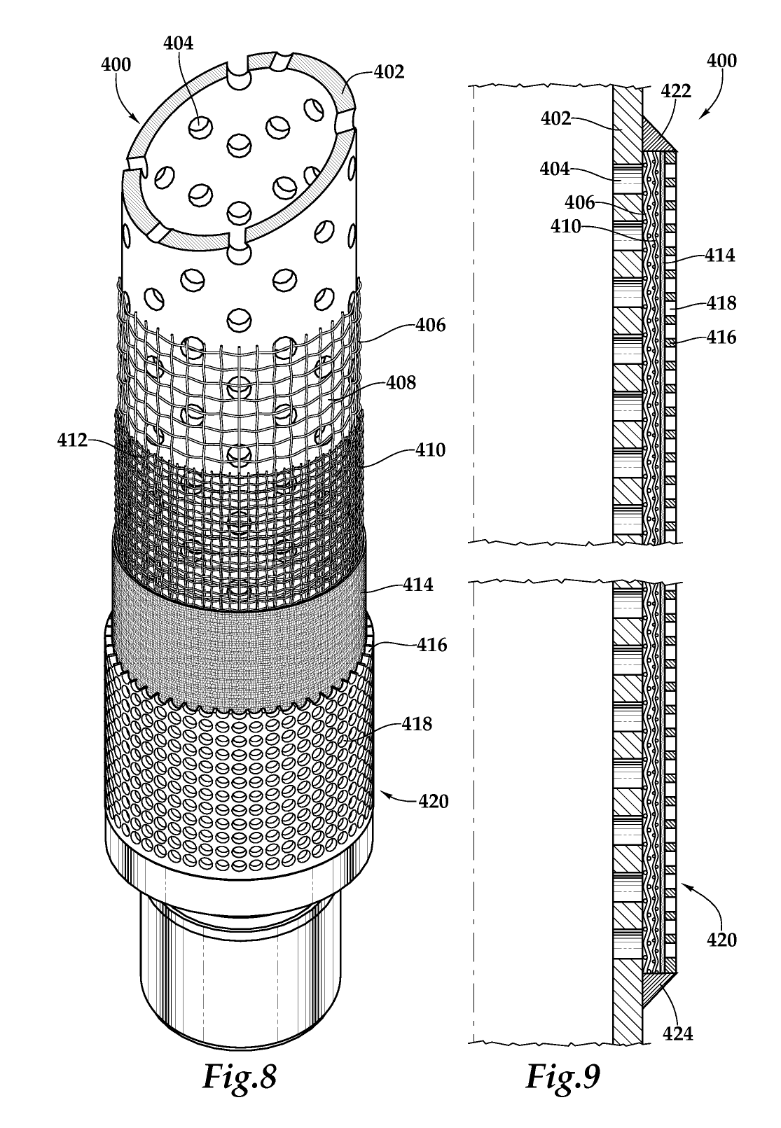

Referring to FIGS. 8-9, still yet another embodiment of a sand control screen assembly having surface-modified filter medium is depicted and generally designated 400. Sand control screen assembly 400 includes a base pipe 402 having a plurality of openings 404. Sand control screen assembly 400 has a multilayer filtration medium including an inner mesh layer 406 having a plurality of openings 408, an intermediate mesh layer 410 having a plurality of openings 412 and an outer mesh layer 414. In one embodiment, mesh layer 414 may be a plain Dutch weave or a twilled Dutch weave wire mesh material. Sand control screen assembly 400 further includes a shroud 416 having a plurality of openings 418.

Generally, mesh layer 414 is intended to act as a flow diffuser rather than as a filter. In particular, in such a weave, the fill wires are separated by warp wires resulting in spaces and a wavy configuration, so that fluid that passes through openings 418 of shroud 416 is deflected by the wires of mesh layer 414 to prevent direct radial flow of fluid through sand control screen assembly 400. The deflected fluid flow passes along the wires and then to the mesh layer 410 for filtration of sand and other particles therefrom. Together, mesh layer 406, mesh layer 410, mesh layer 414 and shroud 416 form sand control screen jacket 420. Sand control screen jacket 420 is attached to base pipe 402 at its upper end by weld 422 and its lower end by weld 424. Preferably, each of the mesh layers 406, 410, 414 is treated with the surface-modified agent of the present invention. Use of the surface-modified agent on the mesh layers 406, 410, 414 enhances the filtering characteristics thereof.

Referring now to FIG. 10, an embodiment of a surface-modified filter medium is depicted and generally designated 500. Surface-modified filter medium 500 includes prepack sand including sand particles 502 having a surface-modified agent 504 coated on at least a portion of sand particles 502. Surface-modified filter medium 500 further includes matrix pores 506 created by the spaces between sand particles 502 and surface-modified agent 504. It is noted that the edges of each sand particles 502 and the coating of surface-modified agent 504 may be irregular in shape, and that matrix pores 506, may also be irregular in shape.

Referring now to FIG. 11, an embodiment of a surface-modified filter medium is depicted and generally designated 520. Surface-modified filter medium 520 includes prepack gravel including gravel particles 522 having a surface-modified agent 524 coated on at least a portion of gravel particles 522. Surface-modified filter medium 520 further includes matrix pores 526 created by the spaces between gravel particles 522 and surface-modified agent 524. It is noted that the edges of each gravel particles 522 and the coating of surface-modified agent 524 may be irregular in shape, and that matrix pores 526, may also be irregular in shape.

Even though two exemplary embodiments of surface-modified filter media having two substantially uniform particle sizes have been shown, those skilled in the art will understand that a surface-modified filter medium of the present invention could include particles having any desired size, ratio of sizes or combination sizes without departing from the principles of the present invention. Also, even though the surface-modified agent is depicted as forming a substantially uniform coating on the particle, those skilled in the art will understand that the surface-modified agent may alternatively, form a non-uniform coating on the particles that may fully or partially encapsulate the particles. In addition, it should be noted that the pack sand for prepacked sand control screen assemblies has typically included a consolidating resin that requires a heat treatment to cure. The use of a surface-modified agent of the present invention, however, may eliminate the need for consolidation resins, thus lowering manufacturing costs.

Referring now to FIG. 12, an embodiment of a surface-modified filter medium is depicted and generally designated 540. Surface-modified filter medium 540 includes surface modified fabric mesh material 542 having a surface-modified agent 544 coated on at least a portion thereof. Surface-modified filter medium 540 further includes matrix pores 546 created by the spaces between the fabric elements of surface-modified filter medium 540.

Referring now to FIG. 13, an embodiment of a surface-modified filter medium is depicted and generally designated 560. Surface-modified filter medium 560 includes wire mesh 562 having a surface-modified agent 564 coated on at least a portion of wire mesh 562. Surface-modified filter medium 560 further includes matrix pores 566 created by the spaces between wire mesh 562.

The surface-modified agent of the present invention generally create a surface that attracts and holds silica fines, silica clays, and fine particles produced during operation of any of sand control screen assembly having a surface-modified filter medium. In one instance, the surface-modified agent acts as an electrostatic filter by trapping particles at the surface, thus preventing them from proceeding to the depths of the filter medium of a particular sand control screen. This produces a sand control screen that operates as a surface type filter system, including all of the benefits of such systems, like ease of cleaning the surface of the filter while retaining conductivity through sand control screen assembly.

In addition, the surface-modified agent of the present invention alters the pore throat size of matrix pores to prevent silica fines, silica clays, and fine particles from entering into the depths of sand control screen assembly. In certain embodiments, the surface-modified agent of the present invention is a polymer that has nodular, hook-like components distributed along the chemically stable polymer's backbone that attracts or creates attraction to fine particulates.

Whenever two or more surface-modified agent molecules contact each other, the hook-like components tend to interlock. The forces supporting this interlock are generally weak Van der Waal forces, but these forces are additive, resulting in high cohesiveness. Suitable surface-modified agents are capable of forming at least a partial coating upon the surface of the filter medium. In certain embodiments, the surface-modified agents of the present invention are activated, for example, destabilized, coalesced or reacted, to transform the compound into a sticky, surface-modified agent at a desirable time. Such activation may occur before, during, or after the surface-modified agent is coated onto filter medium. This may be done during any part of the assembly and manufacturing processes of the sand control screen assembly. In some embodiments, a pretreatment may be applied to the surface of filter medium to prepare it to be coated with the surface-modified agent.

In one embodiment, the surface-modified agent may be an aqueous based or activated molecule. Examples of aqueous surface-modified agents suitable for use in the present invention include, but are not limited to, acrylic acid polymers, acrylic acid ester polymers, acrylic acid derivative polymers, acrylic acid homopolymers, acrylic acid ester homopolymers, such as poly(methyl acrylate), poly(butyl acrylate), and poly(2-ethylhexyl acrylate), acrylic acid ester copolymers, methacrylic acid derivative polymers, methacrylic acid homopolymers, methacrylic acid ester homopolymers, such as poly(methyl methacrylate), poly(butyl methacrylate), and poly(2-ethylhexyl methacryate), acrylamido-methyl-propane sulfonate polymers, acrylamido-methyl-propane sulfonate derivative polymers, acrylamido-methyl-propane sulfonate copolymers, and acrylic acid/acrylamido-methyl-propane sulfonate copolymers and combinations thereof.

As noted above, suitable aqueous surface-modified agents may be charged polymers that preferentially attach to the surfaces of the filter medium having an opposite charge therefrom. For instance, an aqueous surface-modified agent having a negative charge will preferentially attach to surfaces having a positive to neutral zeta potential and/or a hydrophobic surface. Similarly, using analogous chemistry, a positively charged aqueous surface-modified agent will preferentially attach to negative to neutral zeta potential and/or hydrophilic surfaces. In particular embodiments where the surface being treated lacks an adequately receptive surface, that is, the surface being treated lacks a charge substantially opposite of the chosen aqueous surface-modified agent, a pretreatment fluid may be used to make the surfaces of filter medium more receptive to the aqueous surface-modified agent.

For example, pretreatments may include a cationic polymer to treat a surface with a negative zeta potential or an anionic pretreatment to treat a surface with a positive zeta potential. As will be understood by one skilled in the art, amphoteric and zwitterionic pretreatment fluids may also be used so long as the conditions they are exposed to during use are such that they display the desired charge. Suitable pretreatment fluids include charged fluids comprising a charged surfactant, a charged polymer or a combination thereof. As will be understood by one of skill in the art, with the benefit of this disclosure, the use of a pretreatment is optional and depends, at least in part, on the charge disparity or lack thereof between the chosen surface-modified agent and the surface of filter medium being treated.

As mentioned above, an aqueous surface-modified agent may become more effective when contacted with an activator. Typically, the activator is an organic acid or an anhydride of an organic acid that is capable of hydrolyzing in water to create an organic acid, an inorganic acid, an inorganic salt, such as a brine, a charged surfactant, a charged polymer, or a combination thereof, but any substance that is capable of making the aqueous surface-modified agent insoluble in an aqueous solution may be used as an activator in accordance with the teachings of the present invention. The choice of an activator may vary, depending on factors including the composition of the aqueous surface-modified agent. An example of one activator suitable for use in the present invention is an acetic acid/acetic anhydride blend. Other acids, acids salts, anhydrides, and mixtures thereof are also suitable. Suitable salts include, but are not limited to, sodium chloride, potassium chloride, calcium chloride, and mixtures thereof. In another exemplary embodiment of the present invention, the concentration of salts or other activating compounds present in the formation water itself may be sufficient to activate an aqueous surface-modified agent. In such an embodiment it may not be necessary to add an external activator.

Generally, when used, the activator is present in an amount in the range of from about 0.1% to about 40% by weight of the fluid volume, however, in some cases such as with brines, the activator may be in excess of the aqueous surface-modified agent. Nevertheless, any compound that will cause the activation of the aqueous surface-modified agent, e.g., causing the aqueous surface-modified agent to become insoluble, may be used and is considered within the teachings of the present invention, regardless of the concentration of activator necessary to trigger the activation of the surface-modified agent.

The suitable activators are substantially the same as the suitable pretreatment fluids when used in suitable amounts and in a suitable time period. For example, where the same chemical or chemicals are used as a pretreatment fluid and as an activator, the pretreatment fluid may make up only from about 0.1% to about 5% of the volume of the total amount used. One skilled in the art will recognize that the pretreatment fluid is primarily used to prepare a surface to accept an aqueous surface-modified agent and, generally, will not be used in an amount sufficient to substantially activate the aqueous surface-modified agent.

The surface-modified agent is preferably coated onto sand particles 502, gravel particles 522, fabric mesh 542 or wire mesh 562 prior to or during assembly of sand control screen. Alternatively, any of the sand control screen assemblies of the present invention may be manufactured with the desired filter medium and then treated or coated with the desired surface-modified agent. In these embodiments, the surface-modified agent may be applied or coated onto all or part of the filter medium by means commonly known to those skilled in the art include, but not limited to, spraying, coating, dipping, flowing, brushing, vapor deposition, electrolysis, vacuum deposition, calendering, roller coating, electrostatic spraying and the like. Further, once the surface-modified agent is applied or coated onto all or a portion of the filter medium, the surface-modified agent may be activated by contact with the activator agent.

While this invention has been described with reference to illustrative embodiments, this description is not intended to be construed in a limiting sense. Various modifications and combinations of the illustrative embodiments as well as other embodiments of the invention, will be apparent to persons skilled in the art upon reference to the description. It is, therefore, intended that the appended claims encompass any such modifications or embodiments.

What is claimed is:

1. A sand control screen assembly comprising:
a perforated base pipe that allows fluid flow therethrough;
a filter medium disposed exteriorly about the base pipe; and
a surface-modified agent disposed on at least a portion of the filter medium, the surface-modified agent operable to enhance the surface filter characteristics of the filter medium, thereby reducing particulate infiltration into the filter medium.

2. The sand control screen assembly as recited in claim 1 wherein the filter medium is selected from the group consisting of prepack sand, prepack gravel, fabric mesh and wire mesh.

3. The sand control screen assembly as recited in claim 1 wherein the surface-modified agent is selected from the group consisting of an acrylic acid polymer, an acrylic acid ester polymer, an acrylic acid derivative polymer, an acrylic acid homopolymer, an acrylic acid ester homopolymer, an acrylamido-methyl-propane sulfonate polymer, an acrylamido-methyl-propane sulfonate derivative polymer, an acrylamido-methyl-propane sulfonate copolymer, an acrylic acid/acrylamido-methyl-propane sulfonate copolymer, copolymers thereof and mixtures thereof.

4. The sand control screen assembly as recited in claim 1 wherein the surface-modified agent is activated by an activator.

5. The sand control screen assembly as recited in claim 4 wherein the activator is selected from the group consisting of an organic acid, an anhydride of an organic acid, an inorganic acid, an inorganic salt, a charged surfactant, a charged polymer and combinations thereof.

6. The sand control screen assembly as recited in claim 1 further comprising at least one of a wire screen disposed between the base pipe and the filter medium and a wire screen disposed exteriorly of the filter medium.

7. The sand control screen assembly as recited in claim 1 further comprising a pretreatment at least partially disposed between the filter medium and the surface-modified agent operable to enhance the surface receptivity of the filter medium.

8. A sand control screen assembly comprising:
a perforated base pipe that allows fluid flow therethrough;
a first screen element disposed exteriorly about the base pipe;
a second screen element disposed exteriorly of the first screen element forming a region therebetween;
a prepack filter medium disposed in the region between the first and second screen elements; and
a surface-modified agent disposed on at least a portion of the filter medium, the surface-modified agent operable to enhance the surface filter characteristics of the filter medium, thereby reducing particulate infiltration into the filter medium.

9. The sand control screen assembly as recited in claim 8 wherein the prepack filter medium is selected from the group consisting of prepack sand and prepack gravel.

10. The sand control screen assembly as recited in claim 8 wherein at least one of the first and second screen elements is at least partially coated with the surface-modified agent.

11. The sand control screen assembly as recited in claim 8 wherein the surface-modified agent is selected from the group consisting of an acrylic acid polymer, an acrylic acid ester polymer, an acrylic acid derivative polymer, an acrylic acid homopolymer, an acrylic acid ester homopolymer, an acrylamido-methyl-propane sulfonate polymer, an acrylamido-methyl-propane sulfonate derivative polymer, an acrylamido-methyl-propane sulfonate copolymer, an acrylic acid/acrylamido-methyl-propane sulfonate copolymer, copolymers thereof and mixtures thereof.

12. The sand control screen assembly as recited in claim 8 wherein the surface-modified agent is activated by an activator.

13. The sand control screen assembly as recited in claim 12 wherein the activator is selected from the group consisting of an organic acid, an anhydride of an organic acid, an inorganic acid, an inorganic salt, a charged surfactant, a charged polymer and combinations thereof.

14. The sand control screen assembly as recited in claim 8 further comprising a pretreatment layer at least partially disposed between the filter medium and the surface-modified agent operable to enhance the surface receptivity of the filter medium.

15. A method for making a sand control screen assembly comprising:
providing a base pipe having a plurality of perforation therethrough;
positioning a filter medium exteriorly about the base pipe; and
applying a surface-modified agent to at least a portion of the filter medium, the surface-modified agent operable to enhance the surface filter characteristics of the filter medium, thereby reducing particulate infiltration into the filter medium.

16. The method as recited in claim 15 wherein positioning a filter medium exteriorly about the base pipe further comprises selecting the filter medium from the group consisting of prepack sand, prepack gravel, fabric mesh and wire mesh.

17. The method as recited in claim 15 wherein applying a surface-modified agent to at least a portion of the filter medium further comprises selecting the surface-modified agent from the group consisting of an acrylic acid polymer, an acrylic acid ester polymer, an acrylic acid derivative polymer, an acrylic acid homopolymer, an acrylic acid ester homopolymer, an acrylamido-methyl-propane sulfonate polymer, an acrylamido-methyl-propane sulfonate derivative polymer, an acrylamido-methyl-propane sulfonate copolymer, an acrylic acid/acrylamido-methyl-propane sulfonate copolymer, copolymers thereof and a mixtures thereof.

18. The method as recited in claim 15 further comprising activating the surface-modified agent with an activator selected from the group consisting of an organic acid, an anhydride of an organic acid, an inorganic acid, an inorganic salt, a charged surfactant, a charged polymer and combinations thereof.

19. The method of claim 15 further comprising pretreating the filter medium with one of a cationic compound and a cationic polymer.

20. The method of claim 15 further comprising pretreating the filter medium with one of an anionic compound and an anionic polymer.
